(19) United States
(12) Patent Application Publication
(10) Pub. No.: US 2020/0001379 A1
(43) Pub. Date: Jan. 2, 2020

(54) MILLING TOOL

(71) Applicant: HPTec GmbH, Ravensburg (DE)

(72) Inventor: Stefan NETZER, Wolfegg (DE)

(73) Assignee: HPTec GmbH, Ravensburg (DE)

(21) Appl. No.: 16/564,131

(22) Filed: Sep. 9, 2019

Related U.S. Application Data
(63) Continuation of application No. PCT/EP2018/055672, filed on Mar. 7, 2018.

(30) Foreign Application Priority Data
Mar. 10, 2017 (DE) 20 2017 101 382.0

(51) Int. Cl. B23C 5/10

(52) U.S. Cl. CPC B23C 5/1009; B23C 2210/241; B23C 2210/201; B23C 2210/04

(57) ABSTRACT

A milling tool for milling and/or drilling workpieces, which is rotatable in a direction of rotation about an axis of rotation during machining, comprising a milling head, which has a radius cutter that describes a portion in the form of a circular arc such that the milling head takes up a partially spherical, in particular a hemispherical volume, in rotation, a main body, which has a main feature in the form of a helical recess with respect to the rotation volume taken up by the rotating milling tool in order to form a conveying helix, wherein the main feature is provided with a cutting edge as main cutter, wherein the main feature has a smooth lateral surface arranged on the side facing away from the main cutter in the direction of rotation.

### CROSS REFERENCE TO RELATED APPLICATIONS

This application is a continuation of International Application No. PCT/EP2018/055672 filed Mar. 7, 2018, which designated the United States, and claims the benefit under 35 USC § 119(a)-(d) of German Application No. 20 2017 101 382.0 filed Mar. 10, 2017, the entireties of which are incorporated herein by reference.

### FIELD OF THE INVENTION

The present invention relates to a milling tool for milling workpieces.

### BACKGROUND OF THE INVENTION

Various milling tools are known from the prior art, which make it possible among other things to machine specific materials, for example, to machine plastic, for example, for use in conjunction with the production of dental blanks or the like. In order to make a sufficiently large material cross section available, in some of these tools, the lateral surface of the main body is formed in a ribbed manner in the region of the main feature, or in the region that is located behind the main cutter in the direction of rotation. In this way, the main body is intended to additionally obtain a high level of stability.

### SUMMARY OF THE INVENTION

The object of the present invention is to propose a milling tool that forms an alternative to the prior art and at the same time can be used generally for a wide variety of technical applications.

The milling tool according to the present invention for milling workpieces first of all comprises a main body and, on the head side thereof, a milling head, which has a radius cutter that describes a portion in the form of a circular arc. Thus, if the milling tool is in rotation about its axis of rotation, the milling head takes up a hemispherical rotation volume during this rotation. The angle in cross section through the axis of rotation can differ from 180°, such that the shape also differs from a hemispherical shape, or the rotation volume only generally forms a spherical segment. For machining, i.e. in this case for the milling operation, the milling tool, which is rotatable about an axis of rotation, has a prescribed direction of rotation, in which the cutters move toward the material of the workpiece during the rotation.

The main body has a main feature, which is configured as a helical recess with respect to the rotation volume taken up by the rotating milling tool. This main feature is in turn provided with a cutting edge as main cutter. Via the helical recess, the material of the workpiece that is removed during machining can possibly also be transported away (as in the case of a conveying helix).

Accordingly, the milling tool according to the present invention is distinguished by the fact that the main feature has a smooth lateral surface arranged on the side facing away from the main cutter in the direction of rotation. Surprisingly, it has been found that not only can such a tool according to the present invention be manufactured cost-effectively, because no additional elevations and recesses have to be worked into the lateral surface, but this tool also has very good strength and stability. Even when the milling tool has penetrated a comparatively long way into the material of the workpiece, the smooth surface affords very low frictional resistance, to the extent that the main body comes into contact with the workpiece at all. On account of these properties, the milling tool according to the present invention is usable in principle also for a wide variety of technical areas of application, including for instance the machining of:

plastics, for example, PMMA;

lightweight metals, for instance, aluminum, but also copper or brass;

minerals such as zircon (especially hydrostatically pressed rather than sintered material) and ceramics (especially not fired); and

materials in dental and other medical technology.

In one advantageous embodiment of the present invention, the radius cutter transitions into the main cutter. In this way, the machining commences constantly at the same place at the same time during rotation, even when the tool penetrates deeply into the material, such that continuous machining is achieved without tilting of the cutter and the transporting away of material via the helical recess can also be made easier. The transition between the radius cutter and the main cutter can, but does not necessarily have to have a smooth profile.

Furthermore, in principle two embodiment variants are conceivable, namely a milling tool with a lateral surface that extends parallel to the axis of rotation, or a milling tool in which the lateral surface is inclined with respect to the axis of rotation. If the lateral surface extends parallel to the axis of rotation, it is possible, as a result of this measure, for a tool to be provided, which, in rotation, or the rotation volume of which, has a cylindrical shape as far as possible. Thus, when the workpiece is approached from the side, the main body can carry out planar machining parallel to the axis of rotation. If the milling tool has to penetrate deeply into a material, the cross section or cross sectional area does not change in this embodiment. In the case of a lateral surface that is inclined with respect to the axis of rotation, the lateral surface can be provided, in particular, conically with a cross sectional area that decreases toward the milling head (or increases toward the shank). In this embodiment, the cross sectional area thus becomes greater toward the side on which the tool is clamped in a tool holder of a machine tool. In this way, the milling tool can obtain greater stability. Such a structural measure can be advantageous, in particular, when, in the type of machining provided for the milling tool, it is primarily the milling head, i.e. the “tip” of the tool that is used, i.e. only the milling head is in contact with the workpiece, wherein, even in the case of relatively hard materials of the workpiece, smooth running of the highly stabilized milling tool and thus uniform, precise machining of the workpiece are made possible. Preferably, in this case, the lateral surface encloses an angle of between 0° and at most 20°, inclusive, with the axis of rotation.

It is also possible, in one embodiment of the present invention, for the main cutter to rest partially or entirely on the lateral surface of a cylinder.

Furthermore, in one exemplary embodiment of the present invention, the surface of the rotation volume of the milling tool can be inclined with respect to the axis of rotation. This is, in principle, also the case when the lateral surface of the main body is already inclined with respect to the axis of rotation. The main cutter is regularly raised from the actual lateral surface, i.e. when the main cutter is at a greater radial distance from the axis of rotation than the lateral surface and its external contour thus determines the envelope, i.e. the rotation volume, during the rotation of the milling tool. Here too, preferably angles of between 0° and at most 20° can be provided. As a result of the main cutter standing proud, it is possible, however, for the frictional resistance also to be reduced, in principle, upon deep penetration into the material.

Flanks and/or chip spaces can be provided behind the radius cutter in the direction of rotation. These chip spaces can make it easier to transport the removed material from the workpiece away and additionally reduce the resistance upon penetration of the cutter into the material. The chip spaces can in turn be arranged in a stepped manner. For example, at least two, in particular, three chip spaces can be arranged behind the radius cutter. These chip spaces can each in turn take up different angles to the direction of rotation or rotational path at the corresponding point. They allow, in particular, a stepped profile during the rotation of the tool. The portion cut out of the workpiece can more precisely receive the spherical shape brought about by the radius cutter.

In different embodiment variants of the present invention, the chip spaces can extend in planar manner or with a curved surface; the curvature can be, in particular, away from the surface. While a curved surface allows a transition that is as smooth as possible, as a result of a planar surface of the chip space, as much space as possible for transporting away material can be created.

Flanks, or the contour lines thereof, can extend, in principle, parallel to the radius cutter and/or to the main cutter.

In one development of the present invention, the radius cutter can transition into the main cutter with a smooth profile. With a smooth transition, it is thus possible, even when the tool penetrates deeply into the workpiece, for a continuous transition to be achieved between machining by the milling head and further machining by the main body.

Otherwise, the milling head can also stand proud of the main body by an undercut, however. In such an exemplary embodiment of the present invention, even when the milling tool penetrates into the material, beyond the milling head, with the main body, that part of the main body that adjoins the milling head will initially not contribute toward the machining. Such an embodiment can be appropriate when, for example, mainly the milling head is used for machining. As a result, the machining resistance can also be kept low. Furthermore, it is also possible for the main body to stand proud of the shank and/or for the main cutter to stand proud of the main body by an undercut.

Even when the lateral surface is inclined with respect to the axis of rotation, it is possible, in one development of the present invention, for the portion of the main body that has been conically cut in this way to be adjoined by a cylindrical portion. In particular, the main feature can end in front of the cylindrical portion or transition into the cylindrical portion. If the main feature ends in front of this cylindrical portion, it can, in principle, transition into the portion toward the tool holder, the region of the shank. The type of shaping depends, in particular, on the desired machining. If a part of the main feature is still integrated into the cylindrical portion, this part can also be used for machining. Overall, the tool can be kept slimmer in the cylindrical portion.

With regard to the radius cutter, various developments of the present invention are conceivable. Firstly, in one variant of the present invention, the radius cutter can form the highest point in the feed direction, i.e., as it were, look like a tip of the milling tool. Since the radius cutter as a whole forms the external contour of the rotation volume from one side of the axis of rotation to the other even in the region of the milling head, a spherical region can be cut out of the workpiece even more precisely.

A further embodiment variant relates to the arrangement of the radius cutter along the axis of rotation in plan view of the milling head. Specifically, if the radius cutter is arranged in an offset manner with respect to a plane that contains the axis of rotation, it can exert a greater force or a greater torque on the material to be machined, even in regions close to the axis of rotation. The central portion of the cutter around the axis of rotation in the region of the tip of the tool ensures that an elevation does not remain in the middle or in the center (peg) of the machined workpiece. Preferably, the radius cutter can be offset laterally, counter to the feed direction, with respect to an axis of symmetry of the rotational area taken up by the rotating milling tool. In particular, it can be arranged in its course, for example, such that it intersects at least once two axes of symmetry, extending perpendicularly to one another, of the rotational area taken up by the rotating milling tool. In this way, effective machining can take place.

It has already been stated that exemplary embodiments of the present invention are suitable for different areas of application. As a rule, the milling tool is manufactured, for example, from solid carbide. Advantageously, the milling tool can, in one exemplary embodiment, have a coating, for example, a carbon coating, for example, with diamond. In this way, the chip formation can be improved and the stability of the tool increased.

### EXEMPLARY EMBODIMENT

An exemplary embodiment of the present invention is illustrated in the drawings and explained in more detail in the following text with further details and advantages being given.

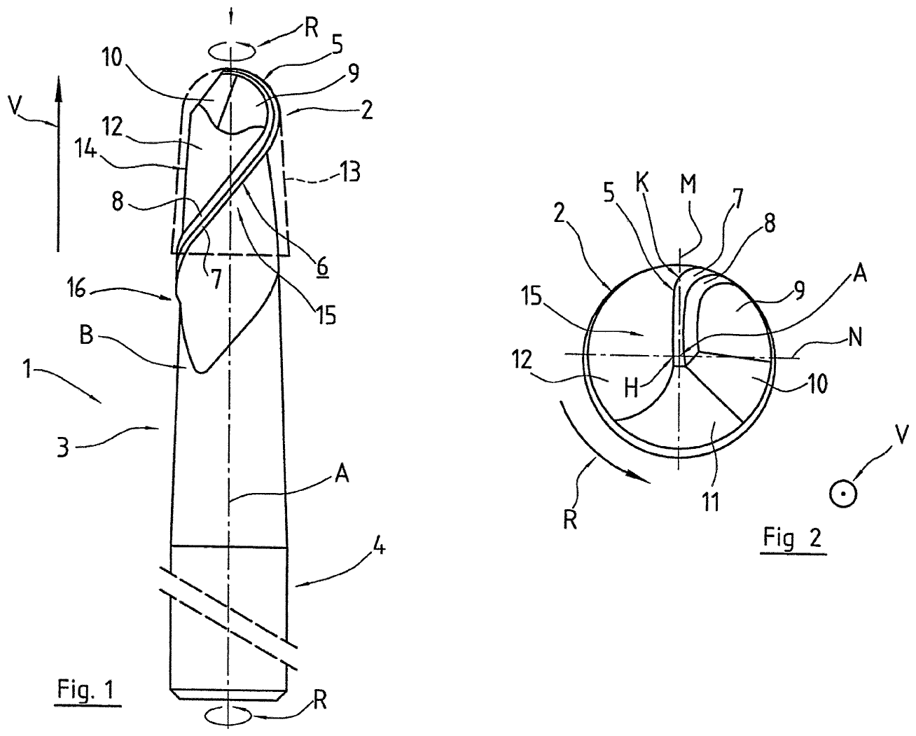

FIG. 1 shows a side view of a milling tool according to the present invention; and

FIG. 2 shows a plan view along the axis of rotation of the milling head of the milling tool from FIG. 1, counter to the feed direction.

### DETAILED DESCRIPTION OF THE INVENTION

FIG. 1 shows a milling tool 1 having a milling head 2, a main body 3, and a cylindrical portion as shank 4. Located on the milling head 2 is a radius cutter 5, which transitions into a main cutter 6 of the main feature in the region of the main body 3. Both the radius cutter 5 and the main cutter 6 are accompanied by in each case two flanks 7, 8, which extend parallel to the respective cutters 5, 6. Furthermore, arranged behind the radius cutter 5 in the direction of rotation R are three chip spaces 9, 10, 11, the surfaces of which are in part planar or curved away from the axis of rotation A. Thus, when the milling tool 1 is in contact with a workpiece in the region of the milling head 2, it exhibits less friction in the region adjoining the radius cutter 5.

Located behind the radius cutter 5 and the flanks 7, 8 in the direction of rotation R is the lateral surface 12, which is formed in a smooth manner. The lateral surface 12 is set back behind the cutters 5, 6 in its distance from the axis of rotation A, and is thus located closer to the axis of rotation A than the cutters 5, 6. The rotation volume 13 is thus determined, in terms of its outer limits, or its surface, by the profile of the cutters 5, 6. Therefore, in the region of the milling head 2, a hemispherical region can be removed from the workpiece to be machined. The outer edge 14 of the lateral surface 12 extends in an inclined manner with respect to the axis of rotation A, wherein the cross sectional area of the milling tool 1, as is also discernible from the body of the rotation volume 13, increases toward the shank 4.

However, the main feature and the main cutter 6 do not pass along the entire main body 3, but end at the point B. The remaining region of the main body 3, which is located beneath the point B toward the shank 4, is formed in a smooth manner. The main feature and the main cutter 6 end, in FIG. 1, above the point B toward the milling head 2, or in that part of the main body 3 that is remote from the shank 4.

The main feature has a clearance 15 beneath the cutter 6, which serves to transport away removed chips or removed material from the workpiece to be machined.

FIG. 2 shows the same milling tool 1 in plan view looking along the axis of rotation A, specifically counter to the feed direction V. If the milling tool 1 is in rotation, the radius cutter 5 meets the workpiece first. Upon further rotation of the milling tool 1, the flanks 7, 8 then follow and then the three chip spaces 9, 10, 11.

Perpendicularly to the axis of rotation A there extend two axes M, N, which each intersect the axis of rotation A. The axes M and N in turn extend perpendicularly to one another. As regards the rotation volume of the milling tool 1, the axes M, N each form axes of symmetry. In its upper region (remote from the shank 4), the radius cutter 5 is arranged in a manner offset laterally (to the left in FIG. 2) with respect to the central axis M, such that a greater force action or a greater torque can be exerted on the workpiece, since, as a result of the offset with respect to the central axis M or to the axis of rotation A, a greater lever can act. The highest point H in the feed direction V is achieved by the radius cutter in the form of a circular arc at the intersection point with the central axis N; subsequently, the radius cutter 5 extends counter to the feed direction V toward the chip space 11. On account of this arrangement, the central axis M is only intersected by the radius cutter 5 in the further course toward the transition into the main cutter 6 at the point K.

The main cutter 6 stands slightly proud of the main body 3 in its course by an undercut in the end region of the main feature. In this way, the actual cutting region stands proud of or is spatially separated from the rest of the milling tool 1 even more.

A common feature of all exemplary embodiments and developments of the present invention is that the main feature has a smooth lateral surface arranged on the side facing away from the main cutter in the direction of rotation.

### LIST OF REFERENCE SIGNS

1 Milling tool
2 Milling head
3 Main body
4 Shank
5 Radius cutter
6 Main cutter
7 Flank
8 Flank
9 Chip space
10 Chip space
11 Chip space
12 Lateral surface
13 Rotation volume
14 Outer edge
15 Clearance
16 Undercut
A Axis of rotation
B End point of the main feature
K Intersection point
M Axis of symmetry
N Axis of symmetry
R Direction of rotation
V Feed direction

1. A milling tool for milling and/or drilling workpieces, which is rotatable in a direction of rotation about an axis of rotation during machining, comprising:
a milling head, which has a radius cutter in the form of a circular arc such that the milling head takes up a partially spherical volume in rotation; and
a main body, which has a main feature in the form of a helical recess with respect to the volume taken up by the rotating milling tool in order to form a conveying helix, wherein the main feature is provided with a cutting edge as a main cutter,
wherein the main feature has a smooth lateral surface arranged on the side facing away from the main cutter in the direction of rotation.

2. The milling tool as claimed in claim 1, wherein the radius cutter transitions into the main cutter.

3. The milling tool as claimed in claim 1, wherein the lateral surface extends parallel to the axis of rotation, and/or wherein the main cutter extends at least partially on the lateral surface of a cylinder.

4. The milling tool as claimed in claim 1, wherein the lateral surface extends in an inclined manner with respect to the axis of rotation, and wherein the lateral surface encloses an angle of between 0° and at most 20°, inclusive, with the axis of rotation.

5. The milling tool as claimed in claim 1, wherein the surface of the volume taken up by the rotating milling tool is inclined with respect to the axis of rotation and extends parallel to the lateral surface to enclose an angle of between 0° and at most 20°, inclusive, with the axis of rotation.

6. The milling tool as claimed in claim 1, further comprising at least one flank arranged behind the main cutter and/or the radius cutter in the direction of rotation.

7. The milling tool as claimed in claim 1, further comprising at least two chip spaces arranged behind the radius cutter in the direction of rotation.

8. The milling tool as claimed in claim 7, wherein at least one of the chip spaces has a planar surface and/or a surface that is curved away from the axis of rotation.

9. The milling tool as claimed in claim 1, wherein the radius cutter transitions into the main cutter smoothly.

10. The milling tool as claimed in claim 1, wherein the milling head extends from the main body and/or the main body extends from the shank and/or the main cutter extends from the main body by an undercut.

11. The milling tool as claimed in claim 1, wherein a portion of the main body has a conically extending lateral surface is adjoined by a cylindrical portion, and the main feature ends in front of the cylindrical portion or transitions into the cylindrical portion.

12. The milling tool as claimed in claim 1, wherein the milling head takes up a hemispherical volume.

13. The milling tool as claimed in claim 3, wherein the main cutter extends entirely on the lateral surface of a cylinder.

14. The milling tool as claimed in claim 4, wherein the lateral surface extends with respect to the axis of rotation conically with a decreasing cross section toward the milling head.

15. The milling tool as claimed in claim 1, further comprising two flanks arranged behind the main cutter and/or the radius cutter in the direction of rotation.

16. The milling tool as claimed in claim 1, further comprising three chip spaces arranged behind the radius cutter in the direction of rotation.
